(19) United States
(12) Patent Application Publication
(10) Pub. No.: US 2025/0253494 A1
(43) Pub. Date: Aug. 7, 2025

(54) LAMINATED BATTERY MODULE

(71) Applicant: TOYOTA JIDOSHA KABUSHIKI KAISHA, Toyota-shi (JP)

(72) Inventor: Kazuma ASAKURA, Okazaki-shi (JP)

(73) Assignee: TOYOTA JIDOSHA KABUSHIKI KAISHA, Toyota-shi (JP)

(21) Appl. No.: 19/023,882

(22) Filed: Jan. 16, 2025

(30) Foreign Application Priority Data
Feb. 2, 2024 (JP) 2024-014998

(51) Int. Cl. H01M 50/507; H01M 50/543

(52) U.S. Cl. CPC H01M 50/507; H01M 50/543

(57) ABSTRACT

In a laminated battery module in which a plurality of laminated cells is stacked together, each of the laminated cells includes an electrode stack, a current collector terminal connected to a current collector foil of the electrode stack, and a laminate film sealing the electrode stack together with the current collector terminal, and further includes a busbar electrically connected to the current collector terminal, the busbars of adjacent ones of the laminated cells are connected to each other by a fastening member, the electrode stacks are restrained in a stacking direction of the electrode stacks, and the current collector terminal and the busbar are allowed to move toward and away from the electrode stack.

### CROSS-REFERENCE TO RELATED APPLICATION

This application claims priority to Japanese Patent Application No. 2024-014998 filed on Feb. 2, 2024, incorporated herein by reference in its entirety.

### BACKGROUND

### 1. Technical Field

The present disclosure relates to laminated battery modules.

### 2. Description of Related Art

A laminated cell is, for example, a cell composed of an electrode stack enclosed and sealed by a laminate film. The electrode stack includes a cathode current collector layer, a cathode active material layer, an electrolyte layer, an anode active material layer, and an anode current collector layer. A battery pack (laminated battery module) described below is known in which current collector terminals of a plurality of laminated cells are connected to each other.

For example, Japanese Unexamined Patent Application Publication No. 2020-087721 (JP 2020-087721 A) discloses a battery pack. This battery pack includes: a cell assembly in which a plurality of battery cells each having electrode terminals (current collector terminals) on its side surfaces is stacked in a stacking direction; a holding member extending in the stacking direction of the battery cells; a plurality of voltage detection terminals held by the holding member and each electrically connected to the electrode terminals; and a plurality of voltage detection lines extending in the stacking direction along the holding member, held by the holding member, and electrically connecting the voltage detection terminals and an external circuit for detecting the voltages of the battery cells. The battery pack of JP 2020-087721 A can improve ease of installation of the voltage detection lines.

### SUMMARY

For example, in such a laminated battery module as described above, a plurality of laminated cells is stacked and electrically connected to each other. In this case, in order to absorb the component tolerance by deformation of the current collector terminals and busbars, it is necessary to reduce the thicknesses of the current collector terminals and the busbars to reduce their rigidity. However, reducing the thicknesses of the current collector terminals and the busbars increases the electrical resistance and thus increases the amount of heat generation during energization, which causes energy loss.

It is therefore an object of the present disclosure to provide a laminated battery module in which a plurality of laminated cells is electrically connected to each other even when their current collector terminals and busbars have high rigidity.

The present disclosure achieves the above object by the following means.

### First Aspect

In a laminated battery module in which a plurality of laminated cells is stacked together,
each of the laminated cells includes an electrode stack, a current collector terminal connected to a current collector foil of the electrode stack, and a laminate film sealing the electrode stack together with the current collector terminal, and further includes a busbar electrically connected to the current collector terminal,
the busbars of adjacent ones of the laminated cells are connected to each other by a fastening member,
the electrode stacks are restrained in a stacking direction of the electrode stacks, and
the current collector terminal and the busbar are allowed to move toward and away from the electrode stack.

### Second Aspect

In the laminated battery module according to the first aspect, the current collector terminal and the busbar may be thicker than the current collector foil and the laminate film.

### Third Aspect

In the laminated battery module according to the first or second aspect, each of the current collector terminal and the busbar may have a thickness of 0.5 mm or more.

### Fourth Aspect

In the laminated battery module according to any one of the first to third aspects, the busbar may include a connection portion connected to the current collector terminal, a fastening portion where the busbars are fastened together, and an intermediate portion connecting the connection portion and the fastening portion,
an angle between a surface having the fastening portion and a surface having the intermediate portion may be 10° to 40°, and
an angle between the surface having the fastening portion and a surface having the connection portion may be substantially 90°.

### Fifth Aspect

In a method for manufacturing a laminated battery module,
the laminated battery module includes a plurality of laminated cells stacked together, and each of the laminated cells includes an electrode stack, a current collector terminal connected to a current collector foil of the electrode stack, and a laminate film sealing the electrode stack together with the current collector terminal. The method includes:
electrically connecting a busbar to the current collector terminal;
restraining the electrode stacks in a stacking direction of the electrode stacks in such a manner that the current collector terminal and the busbar are allowed to move toward and away from the electrode stack; and
connecting the busbars of adjacent ones of the laminated cells to each other by a fastening member.

In the laminated battery module of the present disclosure, the laminated cells are electrically connected to each other even when their current collector terminals and busbars have high rigidity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram illustrating a laminated battery module according to the present disclosure;

FIG. 1B is a schematic diagram illustrating the laminated battery module according to the present disclosure;

FIG. 2A is a schematic diagram illustrating the laminated battery module according to the present disclosure;

FIG. 2B is a schematic diagram illustrating the laminated battery module according to the present disclosure;

FIG. 3A is a schematic diagram illustrating a busbar according to the present disclosure;

FIG. 3B is a schematic diagram illustrating the busbar according to the present disclosure;

FIG. 4A is a schematic diagram illustrating a method for manufacturing a laminated battery module according to the present disclosure;

FIG. 4B is a schematic diagram illustrating the method for manufacturing a laminated battery module according to the present disclosure;

FIG. 4C is a schematic diagram illustrating the method for manufacturing a laminated battery module according to the present disclosure; and

FIG. 4D is a schematic diagram illustrating the method for manufacturing a laminated battery module according to the present disclosure.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

### Laminated Battery Module

The laminated battery module of the present disclosure is a laminated battery module in which a plurality of laminated cells is stacked together, each of the laminated cells includes an electrode stack, a current collector terminal connected to a current collector foil of the electrode stack, and a laminate film sealing the electrode stack together with the current collector terminal, and further includes a busbar electrically connected to the current collector terminal,
the busbars of adjacent ones of the laminated cells are connected to each other by a fastening member,
the electrode stacks are restrained in a stacking direction of the electrode stacks, and
the current collector terminal and the busbar are allowed to move toward and away from the electrode stack.

In the laminated battery module of the present disclosure, the laminated cells are electrically connected to each other even when their current collector terminals and busbars have high rigidity.

Without being limited to the theory, the electrode stack is restrained in the stacking direction of the electrode stacks, and the current collector terminal and the busbar are allowed to move toward and away from the electrode stack. For this reason, specifically, for example, since the current collector foil and the laminate film have low rigidity, the current collector terminal and the busbar are allowed move toward and away from the electrode stack. Therefore, even when the laminated cell has flexibility in a direction perpendicular to the stacking direction of the electrode stack and the rigidity of the current collector terminal and the busbar is large, the component tolerances and the like are absorbed by the flexibility of the laminated cell. Thereby, it is presumed that the laminated cells are electrically connected to each other.

In addition, the volume of the current collector terminal and the busbar is large, and for example, the current collector terminal and the busbar are thick. Accordingly, even when the rigidity of the current collector terminal and the busbar is large, the laminated battery module of the present disclosure electrically connects the laminated cells. Therefore, compared with a laminated battery module manufactured by thinning a current collector terminal and a busbar to have low rigidity, the electric resistance is reduced, and the amount of heat generated during energization is reduced. Thereby, it is assumed that the energy loss is reduced.

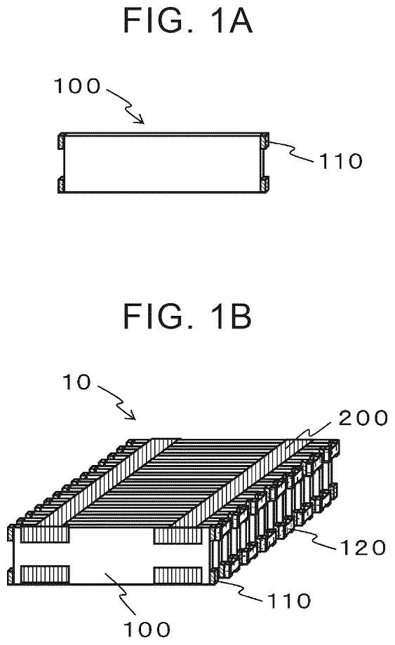

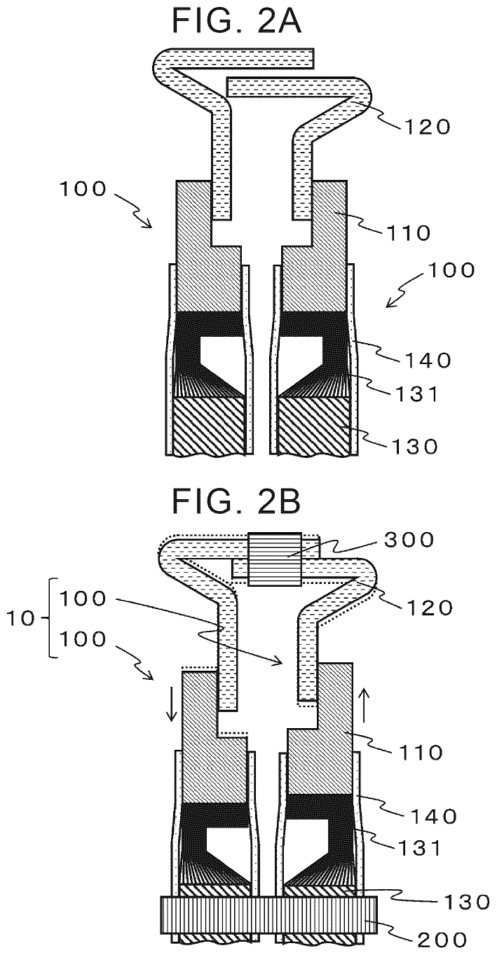

FIGS. 1A to 1B and 2A to 2B are schematic illustrations illustrating one aspect of the disclosed laminated battery module, but are not limited thereto.

In FIG. 1A, one laminated cell 100 included in the laminated battery module 10 is shown. In the laminated cell 100 illustrated in FIG. 1A, four current collector terminals 110 are provided. Namely, two current collector terminals 110 are disposed at upper and lower positions on each of the right and left side surfaces. For example, when the current collector terminal 110 disposed on one side surface is the cathode current collector terminal, the current collector terminal 110 disposed on the other side surface is the anode current collector terminal. FIG. 1B shows a laminated battery module 10. In the laminated battery module 10, a plurality of laminated cells 100 is stacked together in the stacking direction of the electrode stacked body, and are restrained in the stacking direction of the electrode stacked body by a restraining band 200. Busbars 120 of adjacent laminated cells 100 are connected to each other by fastening members. In FIG. 1B, the laminated battery module 10 is arranged so that the current collector terminals of adjacent laminated cells differ from each other in polarity, for example. The laminated cells adjacent to each other in the busbar 120 are electrically connected to each other, so that the laminated cells 100 are electrically connected in series.

In FIGS. 2A and 2B, a cross section of adjacent laminated cells in the vicinity of the busbars is shown. FIG. 2A shows a state in which the laminated cells are not connected to each other by a fastening member, and FIG. 2B shows a state in which the laminated cells are connected to each other by a fastening member. In FIG. 2A, the laminated cell 100 includes an electrode stack 130, a current collector terminal 110 connected to the current collector foil 131 of the electrode stack 130, and a laminate film 140 that seals the electrode stack 130 together with the current collector terminal 110. The laminated cell 100 also includes a busbar 120 electrically connected to the current collector terminal 110. Since the current collector foil 131 and the laminate film 140 have low rigidity, the current collector terminal 110 and the busbar 120 of the laminated cell 100 are allowed to move toward and away from the electrode stack even when the rigidity of the current collector terminal 110 and the busbar 120 is large.

As shown in FIG. 2B, in the present disclosure, in the laminated battery module, the electrode stack 130 is restrained by the restraining band 200 in the stacking direction of the electrode stack 130. The current collector terminal 110 and the busbar 120 are allowed to move toward and away in the stacking direction of the electrode stack 130. When the busbars 120 of adjacent laminated cells are disposed, for example, on the busbars 120 of one of the laminated cells, and the busbars 120 of the other laminated cells are connected to each other by the fastening members 300, the current collector terminals 110 and the busbars 120 of the respective laminated cells move toward and away from the electrode stack 130. Therefore, specifically, since it can be moved in the arrow direction shown in FIG. 2B, the laminated cell 100 has flexibility in a direction perpendicular to the stacking direction of the electrode stack 130, it is possible to absorb the component tolerances and the like by the flexibility of the laminated cell 100. Accordingly, even when the rigidity of the current collector terminal 110 and the busbar 120 is large, the laminated cell 100 is electrically connected to each other.

The structure of the fastening member is not particularly limited, but may be a fastening structure using a bolt and a nut. For example, when a fastening structure using a bolt and a nut is used for the fastening member, the volume of the busbar is further increased, the heat capacity is improved, and the heat radiation area is increased, whereby the heat generation of the battery can be suppressed.

In the laminated battery module of the present disclosure,
the busbar may include, but is not limited to, a connection portion connected to the current collector terminal, a fastening portion to which the busbars are fastened, and an intermediate portion connecting the connection portion and the fastening portion.

The angle between the surface having the fastening portion and the surface having the intermediate portion is not particularly limited, but is preferably 10° to 40°. The angle between the surface having the fastening portion and the surface having the intermediate portion may be 10° or more, 15° or more, or 20° or more, and may be 40° or less, 35° or less, or 30° or less.

The angle between the surface having the fastening portion and the surface having the connection portion is not particularly limited, but is preferably substantially vertical. The angle between the surface having the fastening portion and the surface having the connection portion may be 70° or more, 80° or more, 85° or more, 87° or more, or 89° or more, and may be 110° or less, 100° or less, 95° or less, 93° or less, or 91° or less.

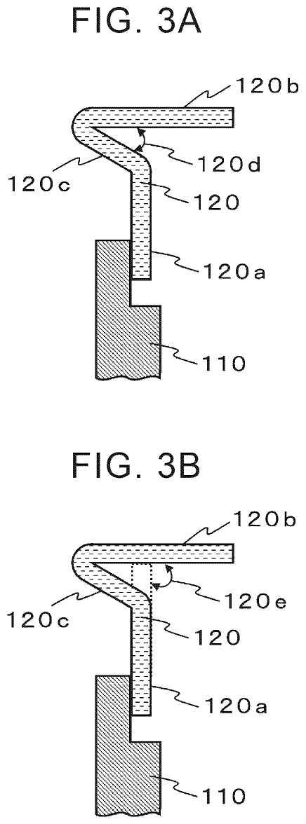

FIGS. 3A and 3B are schematic illustrations of one embodiment of a busbar according to the present disclosure, but is not limited thereto.

In FIG. 3A, the busbar 120 has a connection portion 120a connected to the current collector terminal 110, a fastening portion 120b to which the busbars 120 are fastened, and an intermediate portion 120c connecting the connection portion 120a and the fastening portion 120b. The angle 120d between the surface having the fastening portion 120b and the surface having the intermediate portion 120c is an angle formed by the surface having the fastening portion 120b and the surface having the intermediate portion 120c, and the angle 120d is not particularly limited, but is preferably 10° to 40°. In FIG. 3B, the angle 120e between the surface having the fastening portion 120b and the surface having the connection portion 120a is an angle formed by the surface having the fastening portion 120b and the surface having the connection portion 120a. The angle 120e is not particularly limited, but is preferably substantially perpendicular, and is preferably 70° to 110°. Since the busbar has the configuration shown in FIGS. 3A and 3B, the busbars 120 of the laminated cells adjacent to each other as in FIGS. 2A and 2B are disposed, for example, on the busbars 120 of one laminated cell, and the busbars 120 of the other laminated cell are disposed. When connected to each other by the fastening member 300, as the adjacent laminated cells 100 approach each other, the surface having the fastening portion 120b of the busbar 120 of the laminated cell 100 disposed at the lower portion moves along the surface having the intermediate portion 120c of the busbar 120 of the laminated cell 100 disposed at the upper portion. The current collector terminal 110 and the busbar 120 are allowed to move toward and away from the electrode stack 130. As described above, the load in the unintended direction is reduced in the connection between the laminated cells 100, and thereby the possibility of breakage of the current collector foil 131 or the like of the laminated cell 100 can be reduced.

### Method for Manufacturing Laminated Battery Module

In a method for manufacturing a laminated battery module according to the present disclosure,
the laminated battery module includes a plurality of laminated cells stacked together,
each of the laminated cells includes an electrode stack, a current collector terminal connected to a current collector foil of the electrode stack, and a laminate film sealing the electrode stack together with the current collector terminal. The method includes:
electrically connecting a busbar to the current collector terminal;
restraining the electrode stacks in a stacking direction of the electrode stacks in such a manner that the current collector terminal and the busbar are allowed to move toward and away from the electrode stack; and
connecting the busbars of adjacent ones of the laminated cells to each other by a fastening member.

In the laminated battery module of the present disclosure, the laminated cells are electrically connected to each other even when current collector terminals and busbars of the laminated cells have high rigidity.

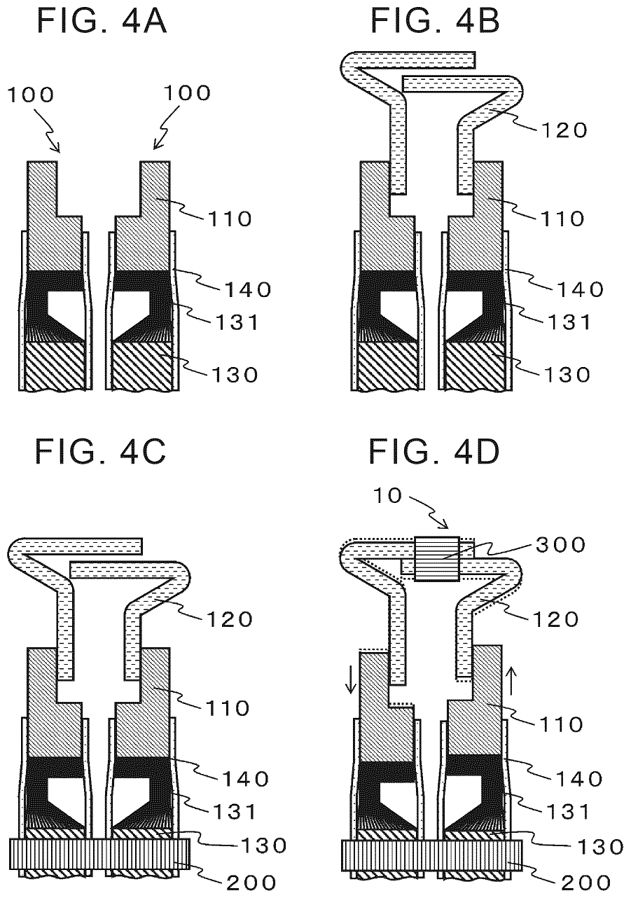

FIGS. 4A to 4D are schematic views illustrating of an aspect of a method for manufacturing a laminated battery module according to the present disclosure. However, the present disclosure is not limited thereto.

In FIGS. 4A to 4D, among the laminated cells stacked on each other, the current collector terminals and the vicinity of the busbars of adjacent laminated cells are shown. As shown in FIG. 4A, the laminated cell 100 includes an electrode stack 130, a current collector terminal 110 connected to the current collector foil 131 of the electrode stack 130, and a laminate film 140 that seals the electrode stack 130 together with the current collector terminal 110. In the laminated battery module manufacturing process of the present disclosure, first, as shown in FIG. 4B, the busbar 120 is electrically connected to the current collector terminal 110. The method of electrically connecting is not particularly limited, but a known method can be appropriately employed. As shown in FIG. 4C, the electrode stacks 130 are then restrained in the stacking direction of the electrode stacks 130 by the restraining band 200 in such a manner that the current collector terminal 110 and the busbar 120 are allowed to move toward and away from the electrode stack 130. Next, as shown in FIG. 4D, the busbars of adjacent laminated cells are connected to each other by the fastening member 300. The electrode stacks 130 are restrained in the stacking direction of the electrode stacks 130 by the restraining band 200 in such a manner that the current collector terminal 110 and the busbar 120 are allowed to move toward and away from the electrode stack 130. As a result, the laminated cell 100 is provided with flexibility in a direction perpendicular to the stacking direction of the electrode stack 130, and the rigidity of the current collector terminal 110 and the busbar 120 is large. Even in this case, component tolerances and the like are absorbed by the flexibility of the laminated cell 100. As a result, the laminated cells 100 can be electrically connected to each other.

### Laminated Battery Module and Method of Manufacturing the Same; Respective Components

Hereinafter, each configuration of the laminated battery module and the manufacturing method thereof will be described.

In the present disclosure, the laminated cell may be a liquid-based battery containing an electrolyte solution as an electrolyte layer, or may be a solid battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte. In addition, in the present disclosure, the laminated cell may be an all-solid-state cell, that is, a cell using only a solid electrolyte as an electrolyte.

In the context of the present disclosure, a “mixture” means a composition capable of forming a cathode active material layer or the like as it is or by further containing other components. In addition, in the context of the present disclosure, the “mixture slurry” means a slurry that includes a dispersion medium in addition to the “mixture” and that can be applied and dried to form a cathode active material layer or the like.

### Laminated Cell

The laminated cell includes a current collector terminal, a busbar, an electrode stack, and a laminate film.

The current collector terminal is connected to the current collector foil of the electrode stack. The current collector terminal may be electrically connected to, for example, a current collector foil as a cathode current collector layer of an electrode stack to be described later, or may be electrically connected to a current collector foil as an anode current collector layer of an electrode stack. The current collector terminal is not particularly limited, but may be made of aluminum, stainless steel (SUS), or the like.

The thickness of the current collector terminal is larger than the thickness of the current collector foil and the laminate film. For example, the thickness of the thicker one of the current collector foil and the laminate film may be 2 times or more, 4 times or more, 6 times or more, 8 times or more, 10 times or more, 15 times or more, 20 times or more, 25 times or more, 30 times or more, 35 times or more, 40 times or more, 45 times or more, or 50 times or more. It may also be 500 times or less, 400 times or less, 300 times or less, 200 times or less, or 100 times or less.

The thickness of the current collector terminal may be 0.5 mm or more, 0.8 mm or more, 1.0 mm or more, 1.5 mm or more, or 2.0 mm or more. Also 10.0 mm below, 9.0 mm below, 8.0 mm below, 7.0 mm below, 6.0 mm below, or may be 5.0 mm below.

### Busbar

The busbar is electrically connected to the current collector terminal. The material of the busbar is not particularly limited, but a metal or the like can be used.

The thickness of the busbar is greater than the thickness of the current collector foil and the laminate film. For example, the thickness of the thicker one of the current collector foil and the laminate film may be 2 times or more, 4 times or more, 6 times or more, 8 times or more, 10 times or more, 15 times or more, 20 times or more, 25 times or more, 30 times or more, 35 times or more, 40 times or more, 45 times or more, or 50 times or more. It may also be 500 times or less, 400 times or less, 300 times or less, 200 times or less, or 100 times or less.

The thickness of the busbars may be 0.5 mm or more, 0.8 mm or more, 1.0 mm or more, 1.5 mm or more, or 2.0 mm or more. Also 10.0 mm below, 9.0 mm below, 8.0 mm below, 7.0 mm below, 6.0 mm below, or may be 5.0 mm below.

### Electrode Stack

The electrode stack is not particularly limited, but may include a cathode current collector layer, a cathode active material layer, an electrolyte layer, an anode active material layer, and an anode current collector layer in this order.

### Cathode Current Collector Layer

A material used for the cathode current collector layer is not particularly limited, but a material generally used as a cathode current collector of a battery can be appropriately adopted. Examples of materials used for the cathode current collector layers include, but are not limited to, Cu, Ni, Cr, Au, Pt, Ag, Al, Fe, Ti, Zn, Co, and stainless-steel. Further, the cathode current collector layer may have some coating layer on the surface thereof for the purpose of adjusting the resistance or the like. The cathode current collector layer may be formed by plating or depositing the metal on a metal foil or a base material.

The shape of the cathode current collector layer is not particularly limited, but may be, for example, a foil shape, a plate shape, or a mesh shape. Among the above, the foil shape is preferred.

The thickness of the cathode current collector layers is not particularly limited, but may be 0.1 μm or more, or 1 μm or more, and may be 1 mm or less, or 100 μm or less.

### Cathode Active Material Layer

The cathode active material layer includes at least a cathode active material, and may further optionally include a solid electrolyte, a conductive auxiliary agent, a binder, and the like. The cathode active material layer may further contain various additives. The content of each of the cathode active material, the solid electrolyte, the conductive auxiliary agent, the binder, and the like in the cathode active material layer may be appropriately determined in accordance with the desired battery performance. For example, the content of the cathode active material may be 40% by mass or more, 50% by mass or more, or 60% by mass or more, or 100% by mass or less, or 90% by mass or less, based on 100% by mass of the entire cathode active material layer (the entire solid content).

### Cathode Active Material

The material of the cathode active material is not particularly limited as long as it can occlude and release lithium ions. For example, the cathode active material may be lithium cobalt oxide (LiCoO₂), lithium nickelate (LiNiO₂), lithium manganate (LiMn₂O₄), lithium nickel manganese cobalt oxide (NCM: LiCO_{1/3}Ni_{1/3}Mn_{1/3}O₂), lithium nickel cobalt aluminum oxide (LiNi_{0.8}(CoAl)_{0.2}O₂), a heteroelement-substituted Li-Mn spinel having a composition represented by Li₁₊ₓMn_{2-x-y}M_{y}O₄ (M is at least one metal element selected from among Al, Mg, Co, Fe, Ni, and Zn), or the like, but the present disclosure is not limited thereto.

The cathode active material is not particularly limited, but may have a coating layer. The coating layer is a layer containing a material having lithium ion conductivity, having low reactivity with a cathode active material or a solid electrolyte, and capable of maintaining a form of a coating layer that does not flow even when in contact with an active material or a solid electrolyte. In addition to LiNbO₃, Li₄Ti₅O₁₂, Li₃PO₄ may be exemplified, but is not limited thereto.

The shape of the cathode active material is not particularly limited as long as it has a general shape as the cathode active material of the battery. The cathode active material may be in a particulate form, for example. The cathode active material may be a primary particle or a secondary particle in which a plurality of primary particles is aggregated. The mean particle diameter D₅₀ of the cathode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. The mean particle diameter D₅₀ is the particle diameter (median diameter) at an integrated value of 50% in the volume-based particle size distribution determined by the laser diffraction/scattering method.

### Solid Electrolyte

The material of the solid electrolyte is not particularly limited, and may be, for example, a sulfide solid electrolyte, an oxide solid electrolyte, or a polymer electrolyte.

Examples of sulfide solid electrolyte include, but are not limited to, a sulfide-based amorphous solid electrolyte, a sulfide-based crystalline solid electrolyte, an argyrodite-type solid electrolyte, and the like. Specific examples of sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

Examples of an oxide solid electrolyte include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), and combinations thereof.

The sulfide solid electrolyte and the oxide solid electrolyte may be glass or crystallized glass (glass ceramics).

Examples of polymer electrolytes include polyethylene oxide (PEO), polypropylene oxide (PPO), copolymers thereof and the like, but are not limited to these.

### Conductive Aid

The conductive aid is not particularly limited. The conductive aid may be, for example, but not limited to, vapor-grown carbon fiber (VGCF), acetylene black (AB), Ketjen black (KB), carbon nanotube (CNT), carbon nanofiber (CNF), and the like. The conductive auxiliary agent may be, for example, particulate or fibrous, and the size thereof is not particularly limited. The conductive auxiliary agent is not particularly limited, but only one kind may be used alone, or two or more kinds may be used in combination.

### Binder

The binder is not particularly limited. The binder may be a material such as, but not limited to, polyvinylidene fluoride (PVdF), butadiene rubber (BR), polytetrafluoroethylene (PTFE), styrene butadiene rubber (SBR), and the like. The binder is not particularly limited, but only one binder may be used alone, or two or more binders may be used in combination.

The shape of the cathode active material layer is not particularly limited, but may be, for example, a sheet-like cathode active material layer having a substantially flat surface. The thickness of the cathode active material layers is not particularly limited, but may be, for example, 0.1 μm or more, 1 μm or more, or 10 μm or more, and may be 2 mm or less, 1 mm or less, or 500 μm or less.

The cathode active material layer can be produced by applying a known method. For example, the cathode active material layer can be easily formed by, for example, dry or wet molding of a cathode mixture containing the above-described various components. The cathode active material layer may be formed together with the cathode current collector layer, or may be formed separately from the cathode current collector layer.

### Electrolyte Layer-Solid Electrolyte Layer

The battery of the present disclosure may have a solid electrolyte layer as a solid battery, i.e., an electrolyte layer. The solid electrolyte layer includes at least a solid electrolyte, and may optionally include a conductive auxiliary agent, a binder, and the like.

For the solid electrolyte, the conductive auxiliary agent, and the binder, reference can be made to the description of “cathode active material layer”.

The thickness of the solid electrolyte layers is not particularly limited, but may be, for example, 0.1 μm or more, 1 μm or more, or 10 μm or more, and may be 2 mm or less, 1 mm or less, or 500 μm or less.

The solid electrolyte layer can be easily formed by, for example, dry or wet molding a solid electrolyte mixture containing the above-described solid electrolyte, binder, and the like.

### Electrolyte Layer-Electrolyte Solution

The battery of the present disclosure may have a liquid-based battery, i.e., an electrolyte retained in an electrolyte, in particular a separator layer, as an electrolyte layer.

### Electrolytic Solution

The electrolyte solution is not particularly limited, but preferably contains a supporting salt and a solvent.

The support salt (lithium salt) of the electrolytic solution having lithium ion conductivity is not particularly limited, and examples thereof include an inorganic lithium salt and an organic lithium salt. Examples of the inorganic lithium salt include, but are not limited to, LiPF₆, LiBF₄, LiClO₄, LiAsF₆. Examples of the organic lithium salt include, but are not limited to, LiCF₃SO₃, LiN(CF₃SO₂)₂, LiN(C₂F₅SO₂)₂, LiN(FSO₂)₂, LiC(CF₃SO₂)₃.

The solvent used in the electrolytic solution is not particularly limited, and examples thereof include cyclic carbonate and chain carbonate. Examples of the cyclic carbonate include, but are not limited to, ethylene carbonate (EC), propylene carbonate (PC), and butylene carbonate (BC). Examples of the chain carbonate include, but are not limited to, dimethyl carbonate (DMC), diethyl carbonate (DEC), ethyl methyl carbonate (EMC), and the like. The electrolytic solution is not particularly limited, but only one kind may be used alone, or two or more kinds may be used in combination.

### Separator

The separator is not particularly limited, but a general separator may be appropriately employed as the separator of the battery. Examples of the separator include polyolefin-based, polyamide-based, and polyimide-based nonwoven fabrics.

### Anode Active Material Layer

The anode active material layer includes at least an anode active material, and may further optionally include a conductive auxiliary agent, a binder, a solid electrolyte, and the like. The anode active material layer may further contain various additives. The content of each of the anode active material, the solid electrolyte, the conductive auxiliary agent, the binder, and the like in the anode active material layer may be appropriately determined in accordance with the desired battery performance. For example, the content of the anode active material may be 40% by mass or more, 50% by mass or more, or 60% by mass or more, and may be 100% by mass or less, or 90% by mass or less, with the total (total solid content) of the anode active material layer being 100% by mass.

### Anode Active Material

As the anode active material, various materials having a potential at which lithium ions are occluded and released (charge and discharge potential) which is a lower potential than that of the cathode active material of the present disclosure can be employed. The material of the anode active material is not particularly limited, and may be metallic lithium or a material capable of occluding and releasing metallic ions such as lithium ions. Examples of the material capable of occluding and releasing metal ions such as lithium ions include, but are not limited to, alloy-based anode active materials, carbon materials, and lithium titanate (Li₄TisO₁₂).

The alloy-based anode active material is not particularly limited, and examples thereof include a Si alloy-based anode active material, a Sn alloy-based anode active material, and the like. The Si alloy-based anode active materials include silicon, silicon oxides, silicon carbides, silicon nitrides, solid solutions thereof, and the like. Si alloy-based anode active material may include a metallic element other than silicon, for example, Fe, Co, Sb, Bi, Pb, Ni, Cu, Zn, Ge, In, Sn, Ti or the like. The Sn alloy-based anode active materials include tin, tin oxide, tin nitride, and solid solutions thereof. Sn alloy-based anode active material may include a metallic element other than tin, for example, Fe, Co, Sb, Bi, Pb, Ni, Cu, Zn, Ge, In, Ti, Si or the like.

The carbon material is not particularly limited, and examples thereof include hard carbon, soft carbon, and graphite.

The shape of the anode active material is not particularly limited, but may be any general shape as the anode active material of the battery. The anode active material may be, for example, in a particulate form or a sheet form.

For the solid electrolyte, the conductive auxiliary agent, and the binder that can be included in the anode active material layer, reference can be made to the above description of “cathode active material layer”.

The shape of the anode active material layer is not particularly limited, but may be, for example, a sheet-like anode active material layer having a substantially flat surface. The thickness of the anode active material layers is not particularly limited, but may be, for example, 0.1 μm or more, 1 μm or more, or 10 μm or more, and may be 2 mm or less, 1 mm or less, or 500 μm or less.

The anode active material layer can be produced by applying a known method. For example, the anode active material layer can be easily formed by, for example, dry or wet molding of the anode mixture containing the above various components. The anode active material layer may be formed together with the anode current collector layer or may be formed separately from the anode current collector layer.

### Anode Current Collector Layer

A material used for the anode current collector layer is not particularly limited, but a material generally used as an anode current collector of a battery can be appropriately adopted. Examples of the material used for the anode current collector layer include, but are not limited to, Cu, Ni, Cr, Au, Pt, Ag, Al, Fe, Ti, Zn, Co, stainless steel, and carbon sheet. The anode current collector layer may have some coating layer on the surface thereof for the purpose of adjusting resistance or the like.

The shape of the anode current collector layer is not particularly limited, but may be, for example, a foil shape, a plate shape, or a mesh shape. Among them, a foil shape is preferable.

The thickness of the anode current collector layers is not particularly limited, but may be 0.1 μm or more, or 1 μm or more, and may be 1 mm or less, or 100 μm or less.

### Laminate Film

The laminate film has a fusion layer and a metal layer. The laminate film may include, but is not limited to, a fusion layer, a metal layer, and a resin layer in this order.

### Bonding Layer

The material of the fusion layer is not particularly limited, and examples thereof include polyolefin resins and the like. Examples of the polyolefin include, but are not limited to, polypropylene (PP) and polyethylene (PE). The thickness of the fusion layer is not particularly limited, but may be 30 μm or more, 40 μm or more, or 50 μm or more, and may be 110 μm or less, 100 μm or less, or 90 μm or less.

### Metal Layer

Examples of the material of the metal layer include, but are not limited to, aluminum, an aluminum alloy, and stainless steel. The thickness of the metal layer is not particularly limited, but may be 20 μm or more, 30 μm or more, or 40 μm or more, and may be 70 μm or less, 60 μm or less, or 50 μm or less.

### Resin Layer

Examples of the material of the resin layer include, but are not limited to, polyethylene terephthalate and nylon. The thickness of the resin layer is not particularly limited, but may be 70 μm or more, 80 μm or more, or 90 μm or more, and may be 270 μm or less, 250 μm or less, or 230 μm or less.

### Fastening Member

The material of the fastening member is not particularly limited. The material of the fastening member is preferably metal from the viewpoint of suppressing heat generation of the battery as described above.

### Applications of Laminated Battery Modules

The laminated battery module in the present disclosure may be, for example, an in-vehicle battery, or may be used as a power source for a moving body other than a vehicle (for example, a railway, a ship, or an aircraft), or may be used as a power source for an electric product such as an information processing apparatus.

Although embodiments of the laminated battery module and the method of manufacturing the laminated battery module of the present disclosure have been described, those skilled in the art will appreciate that changes can be made without departing from the scope of the claims.

What is claimed is:

1. A laminated battery module in which a plurality of laminated cells is stacked together, wherein:
each of the laminated cells includes an electrode stack, a current collector terminal connected to a current collector foil of the electrode stack, and a laminate film sealing the electrode stack together with the current collector terminal, and further includes a busbar electrically connected to the current collector terminal;
the busbars of adjacent ones of the laminated cells are connected to each other by a fastening member;
the electrode stacks are restrained in a stacking direction of the electrode stacks; and
the current collector terminal and the busbar are allowed to move toward and away from the electrode stack.

2. The laminated battery module according to claim 1, wherein the current collector terminal and the busbar are thicker than the current collector foil and the laminate film.

3. The laminated battery module according to claim 1, wherein each of the current collector terminal and the busbar has a thickness of 0.5 mm or more.

4. The laminated battery module according to claim 1, wherein:
the busbar includes a connection portion connected to the current collector terminal, a fastening portion where the busbars are fastened together, and an intermediate portion connecting the connection portion and the fastening portion;
an angle between a surface having the fastening portion and a surface having the intermediate portion is 10° to 40°; and
an angle between the surface having the fastening portion and a surface having the connection portion is substantially 90°.

5. A method for manufacturing a laminated battery module,
the laminated battery module including a plurality of laminated cells stacked together, and
each of the laminated cells including an electrode stack, a current collector terminal connected to a current collector foil of the electrode stack, and a laminate film sealing the electrode stack together with the current collector terminal,
the method comprising:
electrically connecting a busbar to the current collector terminal;
restraining the electrode stacks in a stacking direction of the electrode stacks in such a manner that the current collector terminal and the busbar are allowed to move toward and away from the electrode stack; and
connecting the busbars of adjacent ones of the laminated cells to each other by a fastening member.
